(19) United States
(12) Patent Application Publication
(10) Pub. No.: US 2018/0347108 A1
(43) Pub. Date: Dec. 6, 2018

(54) THREAD AND METHOD FOR PRODUCTION OF SAME

(71) Applicants: SUNLINE CO., LTD., Iwakuni-shi, Yamaguchi (JP); MIZUI CO., LTD., Sakai-shi, Fukui (JP)

(72) Inventors: Keita SUIZU, Iwakuni-shi (JP); Takashi OGAWA, Iwakuni-shi (JP); Hidenobu TSUTSUMI, Iwakuni-shi (JP); Kazuya HAYASHI, Sakai-shi (JP); Kazuaki MIZUI, Sakai-shi (JP); Hidekazu MIYAHARA, Tokyo (JP); Akitoshi OKINO, Tokyo (JP)

(73) Assignees: SUNLINE CO., LTD., Iwakuni-shi, Yamaguchi (JP); MIZUI CO., LTD., Sakai-shi, Fukui (JP)

(21) Appl. No.: 15/778,323

(22) PCT Filed: Jul. 26, 2016
(86) PCT No.: PCT/JP2016/071796

§ 371 Date: May 23, 2018

(30) Foreign Application Priority Data
Nov. 24, 2015 (JP) 2015-229169

(51) Int. Cl. D06M 15/693; A01K 91/00; D06M 10/02; D04C 1/02; D04C 1/06

(52) U.S. Cl. CPC D06M 15/693; A01K 91/00; D06M 2101/20; D04C 1/02; D04C 1/06; D06M 10/02

(57) ABSTRACT

Provided are a yarn which can be easily knotted according to a common knotting method, which is high in knot strength and which can be suppressed in fading of coloration, and a method for production of the same. A yarn in which a plasma treated surface is formed on a surface of an original yarn and the plasma treated surface is covered with rubber. The yarn is preferably made of a synthetic resin, and polyethylene, wholly aromatic polyester and wholly aromatic polyamide are more preferable.

### TECHNICAL FIELD

The present invention relates to a yarn and a method for production of the same. The yarn of the present invention is to be used for a fishing line or the like.

### BACKGROUND ART

Polyamide resins such as nylon, fluororesins such as polyvinylidene fluoride, polyester resins such as polyethylene terephthalate, or polyolefin resins such as polyethylene have been conventionally used as materials of yarns, in particular, fishing yarns. Since yarns made of polyethylene among these resin compositions are high in tenacity at the same yarn diameter as compared with yarns made of nylon and thus can be decreased in yarn diameter at the same tenacity, such yarns can be reduced in conspicuity to fishes when used as fishing lines, are low in water absorbability and ultraviolet absorbability and thus are hardly degraded, and are low in elongation and thus are high in sensitivity as fishing lines. Therefore, fishing lines made of polyethylene have been increasingly popular since selling started at the end of the 20^{th} century.

When yarns made of polyethylene are used as fishing lines, such yarns are generally in the form of twisted yarns or braided yarns where ultrahigh molecular weight polyethylene multifilaments are twisted or braided.

As related arts, there is a fishing line with a cover formed on the surface thereof, the fishing line being obtained by braiding a bundle of high molecular weight polyethylene filaments, wherein the surface is colored by a paint composition (Patent Document 1). In addition, there is a fishing line which is a twisted yarn or braided yarn made of a multifilament yarn of ultrahigh molecular weight polyethylene, wherein the outer surface of the multifilament yarn is metal-plated and the sinking speed in water is increased (Patent Document 2).

### RELATED ART DOCUMENTS

### Patent Documents

### Patent Document 1: Japanese Unexamined Patent Application Publication No. 07-229031

### Patent Document 2: International Publication WO 2009/154202

### SUMMARY OF THE INVENTION

### Problems to be Solved by the Invention

Polyethylene is a material excellent in slippage as compared with nylon and polyvinylidene fluoride. While excellent slippage is one of preferable properties for yarns not limited to fishing lines, such a property has been disadvantageous in that a knot portion is slipped in knotting and knotting is hardly made. There is a special knotting method which hardly causes loosening in knotting of fishing lines made of polyethylene and in connecting of a fishing line made of polyethylene to another member such as a fishhook, such a special knotting method requires learning and is difficult for beginners, and is also difficult to be easily and rapidly performed at a gloomy fishing spot or a good fishing time.

In addition, yarns made of high molecular weight polyethylene filaments are low in strength of a knot portion and/or a node portion, and therefore a knot portion once formed tends to be easily loosened.

Furthermore, there is a fishing line where a colored layer including a colorant is formed on the surface with respect to each certain length in order to readily identify the water depth at which a fishhook is positioned, but ultrahigh molecular weight polyethylene is low in adhesiveness of the colored layer, and the colored layer may be partially peeled off and color-faded due to rubbing in use of the fishing line. These problems have not been sufficiently solved by the fishing lines described in Patent Document 1 and Patent Document 2 different in problems to be solved.

The ability to be easily knotted is demanded with respect to not only a yarn made of polyethylene, but also a yarn made of other synthetic resin, a yarn made of a natural resin, and the like.

The present invention is made for advantageously solving the above problems, and an object thereof is to provide a yarn which can be easily knotted according to a common knotting method, which is high in knot strength and which can be suppressed in fading of coloration, as well as a method for production of the same.

### Means for Solving the Problems

A yarn of the present invention comprises a plasma treated surface formed on a surface of an original yarn and the plasma treated surface is covered with rubber.

In the yarn of the present invention, the yarn is preferably made of at least one synthetic resin selected from polyethylene, wholly aromatic polyester and wholly aromatic polyamide, the yarn is preferably a twisted yarn or a braided yarn, the twisted yarn or the braided yarn is preferably made of a multifilament yarn and the rubber is preferably allowed to penetrate between such multifilament yarns which are adjacent, the rubber is preferably chloroprene rubber, further an outermost layer of the yarn preferably includes a smoothing agent, and still further the yarn is preferably a fishing line. Furthermore, the yarn can be used to provide a long object such as a string, a code or a rope.

A method for producing a yarn of the present invention includes subjecting a surface of an original yarn to a plasma treatment, and covering the surface subjected to a plasma treatment with rubber.

In the method for producing a yarn of the present invention, the original yarn is preferably at least one synthetic resin selected from polyethylene, wholly aromatic polyester and wholly aromatic polyamide, the yarn is preferably a twisted yarn or a braided yarn, the twisted yarn or the braided yarn is preferably made of a multifilament yarn and the rubber is preferably allowed to penetrate between such multifilament yarns which are adjacent, the rubber is preferably chloroprene rubber, further the method preferably includes forming a layer of a smoothing agent after the rubber-coating, and furthermore the plasma treatment is preferably applied at a temperature less than a fusion temperature of the original yarn.

### Effects of the Invention

The yarn of the present invention can be easily knotted according to a common knotting method, is high in knot strength and can be suppressed in fading of coloration.

The method for producing a yarn of the present invention can produce a yarn which can be easily knotted according to a common knotting method, which is high in knot strength and which can be suppressed in fading of coloration.

### BRIEF DESCRIPTION OF THE DRAWINGS

FIG. 1 is a photograph illustrating the cross section of one example of a polyethylene yarn of Example 1.

FIG. 2 is a photograph of the cross section of one example of a polyethylene yarn of Comparative Example 1.

FIG. 3 is a photograph of the cross section of one example of a polyethylene yarn of Comparative Example 10.

FIG. 4 is a graph representing a relationship between the amount of rubber to be compounded and the strength in Examples 2 to 7.

### MODE FOR CARRYING OUT THE INVENTION

In more specific description of the yarn and the method for production of the same of the present invention, a polyethylene yarn and a method for production of the same, according to one embodiment of the present invention, are mainly described. It is noted that the structure and the production method of the yarn in the description below apply to not only a polyethylene yarn, but also yarns made of other synthetic resins such as wholly aromatic polyester and wholly aromatic polyamide, and also apply to a yarn made of a natural resin, a spider silk and a silk yarn.

The yarn of the present invention is a yarn in which a plasma treated surface is formed on the surface of an original yarn and the plasma treated surface is covered with rubber.

The inventors have found that the surface of a yarn made of polyethylene is covered with rubber, to thereby provide a polyethylene yarn which can be easily knotted according to a common knotting method, which is high in knot strength and which can be suppressed in fading of coloration.

However, a yarn made of polyethylene is low in adhesiveness to rubber, and thus such a yarn made of polyethylene has been difficult to cover with rubber at a sufficient adhesion strength only by covering such as simple coating.

The inventors have then promoted further research and development, and as a result, have found that the surface of a yarn made of polyethylene can be subjected to a plasma treatment and the surface subjected to a plasma treatment, namely, the plasma treated surface can be covered with rubber, to thereby cover the yarn made of polyethylene with rubber at a sufficient adhesion strength, thereby sufficiently achieving the following effects: easy knotting according to a common knotting method can be made, knot strength is high and fading of coloration can be suppressed. The inventors have also found that even yarns of other synthetic resins such as wholly aromatic polyester and wholly aromatic polyamide, a natural resin yarn, a spider silk, and the like can each achieve the same effects by subjecting the yarn surface to a plasma treatment and covering the surface subjected to a plasma treatment with rubber, thereby leading to the present invention.

The reason why the above effects are achieved by a plasma treatment, while not necessarily clear, is considered based on one hypothesis: the surface of an original yarn is subjected to a plasma treatment to thereby allow the ratio of a hydrophobic group and a hydrophilic group on the surface of the yarn to be changed as compared with the case of no plasma treatment.

Nevertheless, even if the structure and characteristics of the plasma treated surface of a polyethylene yarn as one example of the yarn of the present invention are analyzed by analytical equipment of university, differences from the structure and characteristics of the surface of a yarn made of polyethylene subjected to no plasma treatment have not been clear. Accordingly, identification of the plasma treated surface in terms of the structure and characteristics is considered to be technically impossible currently. It, however, has been confirmed that the surface of a yarn made of polyethylene is subjected to a plasma treatment and the plasma treated surface is covered with rubber, to thereby provide a polyethylene yarn high in node strength and knot strength and favorable in rubbing fastness as compared with the case of no plasma treatment. This is also understood by Examples described below.

In addition, the yarn of the present invention, for example, a polyethylene yarn, in which the plasma treated surface is covered with rubber, is enhanced in strength and furthermore is decreased in ingress of water between filaments as compared with conventional polyethylene yarns, specifically, a yarn made of only polyethylene, and a polyethylene yarn where a yarn made of polyethylene is covered with a synthetic resin.

The original yarn of the yarn made of polyethylene, to be subjected to a plasma treatment, is made of a polyethylene yarn, preferably an ultrahigh molecular weight polyethylene yarn. The mass average molecular weight of the ultrahigh molecular weight polyethylene here used is preferably 1,000,000 or more, more preferably 2,000,000 or more. When the yarn made of polyethylene is a twisted yarn or braided yarn of multifilament, the single yarn fineness is preferably 0.5 to 10 dTex, more suitably 5 dTex or less, further suitably 3 dTex or less. The fineness of the multifilament yarn is preferably 5 to 6,000 dTex.

The yarn made of polyethylene may be monofilament, but a twisted yarn or a braided yarn is more preferably used. A twisted yarn or a braided yarn is used, to thereby allow single yarns to be mutually densely contacted, thereby providing a fishing line favorable in handleability. In particular, a braided yarn is more preferable because twisting hardly occurs. A twisted yarn or a braided yarn is preferably obtained by twisting or braiding by use of a plurality of multifilament yarns. A yarn includes a large number of fine single yarns, to thereby provide a high-strength yarn with flexibility kept.

The number of multifilament yarns and the diameter of a single yarn constituting a twisted yarn or a braided yarn can be appropriately set depending on the application of the polyethylene yarn, for example, the number of yarns and the diameter adapted to a fishing line.

The original yarn to be subjected to a plasma treatment is not limited to the yarn made of polyethylene, and a fiber made of a fiber forming material or a combination of such fibers can be used.

Examples of the fiber made of a fiber-forming material include a polyamide fiber made of each of nylon 6, nylon 66, nylon 610, poly (p-phenyleneterephthalamide) and a copolymer including them, a polyester fiber made of each of polyethylene terephthalate, polybutylene terephthalate, polybutylene succinate, a copolymer of p-hydroxybenzoic acid with 6-hydroxy-2 naphthoic acid, and a copolymer including them, a fluorocarbon fiber made of each of polyvinylidene fluoride, polytetrafluoroethylene and a copolymer including them, a poly (p-phenylenebenzobisoxazole) fiber, a polyacrylonitrile type fiber, a polyurethane fiber, a cellulose type fiber such as viscos rayon, and a fiber made of protein, such as a spider silk and a silk yarn. With respect to a combination of such original yarns, the types of fibers and the mixing ratio thereof can be appropriately selected depending on the intended characteristics such as specific gravity, strength, flexibility and texture.

In particular, strength is demanded in the fishing line application, and it is preferable to combine, as a main component, a fiber where a fiber of the ultrahigh molecular weight polyethylene, a fiber of wholly aromatic polyamide such as poly (p-phenyleneterephthalamide or a fiber of wholly aromatic polyester such as a copolymer of p-hydroxybenzoic acid with 6-hydroxy-2 naphthoic acid is adopted singly or in combination of two or more thereof, with a fiber other than them.

In an example where the original yarn is made of polyethylene, a yarn made of polyethylene, having a shape of a twisted yarn, a braided yarn or the like, is subjected to a plasma treatment to form a plasma treated surface on the surface of the yarn.

After the plasma treatment, the plasma treated surface of the yarn made of polyethylene is covered with rubber. The rubber may be any of natural rubber and synthetic rubber. Examples of the synthetic rubber can include rubber made of isoprene, rubber made of butadiene, rubber made of styrene-butadiene, rubber made of chloroprene, rubber made of nitrile, rubber made of polyisobutylene, rubber made of urethane, and rubber made of silicone. Among them, chloroprene rubber is preferably used. The rubber can, if necessary, contain various compounding agents such as an antioxidant.

The rubber can contain a colorant. The colorant which can be used is, for example, any of various pigments, and can contain one or more pigments in proper amounts depending on the application of a fishing line or the like.

The amount of the rubber with which the yarn made of polyethylene is to be covered can be adjusted depending on the thickness of the covering film of the rubber and the concentration of the rubber in a dispersion liquid. The dispersion liquid here used means a rubber dispersion liquid with which the original yarn is to be impregnated for rubber-covering. The amount of covering with the covering film of the rubber can be appropriately selected depending on the application of the polyethylene yarn, for example, characteristics demanded for a fishing line. For example, in the case of a fishing line, the thickness of the covering film of the rubber is enhanced to thereby increase the specific gravity of a fishing line, thereby facilitating sinking under water. In addition, the texture and tension of the surface of a fishing line vary depending on the thickness of the covering film of the rubber, and therefore the thickness of the covering film of the rubber can be adjusted so as to impart proper texture and tension.

The surface of a yarn, such as a polyethylene yarn, rubber-covered after a plasma treatment is glossy and smooth as compared with the surface of a yarn rubber-covered without any plasma treatment. Although the cause for this is not clear, any distinct difference in surface texture of a yarn rubber-covered is obtained depending on the presence of a plasma treatment.

In addition, a yarn, such as a polyethylene yarn, rubber-covered after a plasma treatment is uniform in the thickness of a rubber layer and strongly adheres to the yarn made of polyethylene as compared with a yarn rubber-covered without any plasma treatment. Accordingly, there is less fading of coloration of the colorant contained in the rubber.

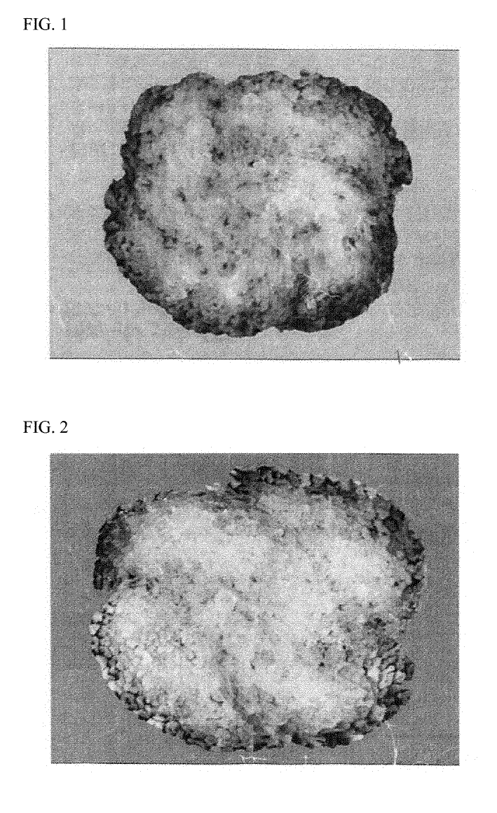

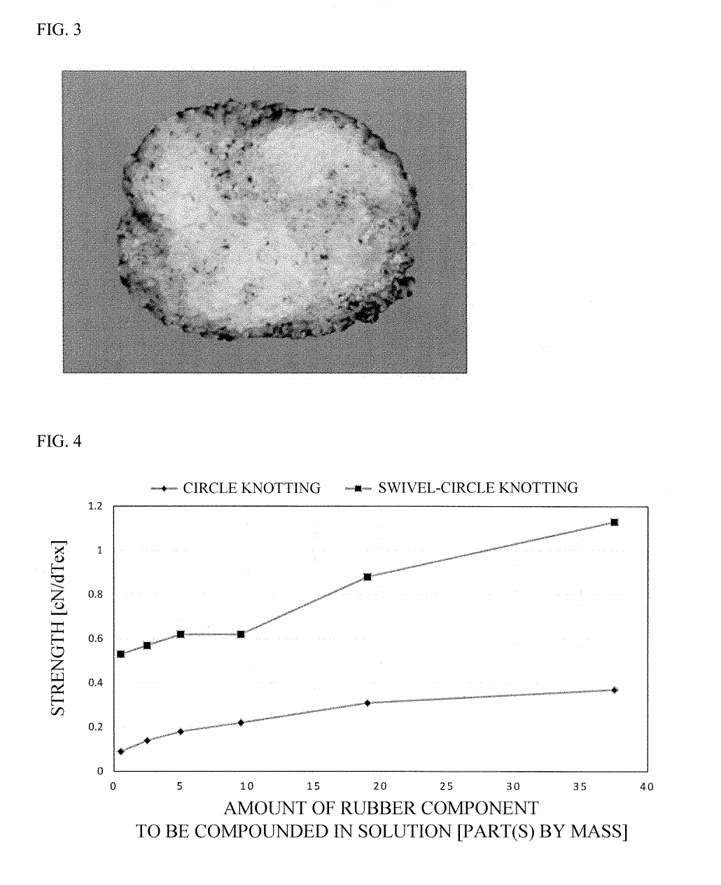

Furthermore, when the original yarn is a twisted yarn or braided yarn of a multifilament yarn, the rubber penetrates between such multifilament yarns which are adjacent, in a yarn, such as a polyethylene yarn, rubber-covered after a plasma treatment. FIG. 1 is a photograph illustrating the cross section of one example of a polyethylene yarn of Example 1 of the present invention, described below. In addition, FIG. 2 is a photograph of the cross section of one example of a polyethylene yarn of Comparative Example 1, described below, in which the surface of the yarn made of polyethylene is covered with a urethane resin without any plasma treatment for comparison. Furthermore, FIG. 3 is a photograph of the cross section of one example of a polyethylene yarn of Comparative Example 10, described below, in which the surface of the yarn made of polyethylene is covered with rubber and covered with amino-modified silicone without any plasma treatment for comparison.

In the polyethylene yarn of Example 1 in FIG. 1, the rubber is present at the interface among four multifilament yarns. In other words, it can be seen that the rubber penetrates between adjacent multifilament yarns. On the contrary, in a polyethylene yarn where the surface of the yarn made of polyethylene is covered with a urethane resin without any plasma treatment in FIG. 2, the urethane resin is present in the outer surface, but the urethane resin is almost not present at the interface among four multifilament yarns. In other words, the urethane resin hardly penetrates between adjacent multifilament yarns. In addition, in a polyethylene yarn where the surface of a yarn made of polyethylene is covered with rubber without any plasma treatment in FIG. 3, the rubber is present in the outer surface, but the rubber is not almost present at the interface among four multifilament yarns. In other words, the rubber does not almost penetrate between adjacent multifilament yarns.

The yarn of the present invention enables the surface of the yarn to be covered with rubber, and enables ingress of water between multifilament yarns to be prevented by the above-described internal penetration of the rubber. According to the yarn of the present invention, the following caused in a conventional polyethylene yarn is not caused: ingress of water between multifilament yarns results in an increase in weight of a yarn, causing deterioration in operation property, and/or sea water penetrating between multifilament yarns is dried to form a salt crystal and such a crystal damages filament. That is, a yarn such as a polyethylene yarn excellent in operation property and excellent in durability is obtained.

In order to more certainly prevent ingress of water between multifilament yarns, silicone rubber having water repellency can be used for the rubber.

In the present invention, the yarn can include a smoothing agent on the outermost layer thereof. The smoothing agent is a modified silicone such as an amino-modified silicone or an epoxy-modified silicone, a straight silicone such as dimethylsilicone, a fluorine-containing oil, or the like. A silicone such as an amino-modified silicone, an epoxy-modified silicone or dimethylsilicone, or a fluorine-containing oil is applied onto a rubber-covering film to thereby allow the yarn including a smoothing agent layer on the outermost layer thereof to be low in friction coefficient and excellent in water repellency. Accordingly, a polyethylene yarn including a covering layer of a silicone such as an amino-modified silicone, an epoxy-modified silicone or dimethylsilicone, or a fluorine-containing oil on the outermost layer thereof can allow ingress of water between multifilament yarns to be more prevented, and is then a polyethylene yarn more excellent in operation property and more excellent in durability.

The yarn of the present invention can be used in various applications in industry fields by means of characteristics such as high strength, knotability and no color fading. The yarn is particularly suitable for a fishing line. The yarn can be used for agricultures such as bird-repelling, in addition to a fishing line, by means of easily knotting characteristics and the like. In addition, the yarn can be used for clothes, in particular, bullet-proof/stab-proof vests and the like, by means of characteristics of no color fading.

Furthermore, the yarn of the present invention can be formed into a long object such as a string, a code, a rope or a net. In the mode of a string, a code, a rope, a net or the like, the surface of an original yarn can be subjected to a plasma treatment and a yarn covered with rubber can be twisted or braided on the plasma treated surface, to thereby impart the shape of a string, a code, a rope, a net or the like. Alternatively, the original yarn can be twisted or braided, to thereby impart the shape of a long object such as a string, a code, a rope or a net, and the surface of the string, rope, rope cable, mesh or the like can be then subjected to a plasma treatment, to cover the plasma treated surface with rubber.

The method for producing a yarn of the present invention includes subjecting a surface of an original yarn to a plasma treatment, and covering the surface subjected to a plasma treatment, with rubber.

The plasma treatment method is not particularly limited. For example, a plasma treatment apparatus illustrated in FIG. 12 in International Publication No. WO 2014/167626 can be used. The plasma treatment is performed to thereby allow the surface of a yarn made of polyethylene to be easily covered with rubber. The plasma treatment can be performed by appropriately selecting proper conditions among known treatment conditions of an existing plasma treatment apparatus. A preferable plasma treatment is a plasma treatment under a condition where an ultrahigh molecular weight polyethylene yarn constituting a twisted yarn or a braided yarn is not mutually fused, for example, a plasma treatment at a low temperature less than the fusion temperature. The plasma treatment under a condition where an ultrahigh molecular weight polyethylene yarn is not mutually fused provides a polyethylene yarn with rubber penetrating between multifilament yarns constituting a twisted yarn or a braided yarn, the polyethylene yarn being high in node strength and knot strength, being favorable in rubbing fastness, being enhanced in strength and also further enhanced in water repellency.

The plasma treatment may be performed not only in a yarn in the form of a twisted yarn or a braided yarn, but also in a multifilament yarn before twisting or braiding. Even in the case of being performed in a yarn in the form of a twisted yarn or a braided yarn, or the case of being performed in a multifilament yarn before twisting or braiding, a plasma treated surface is formed on the surface of the yarn.

Examples of the method for covering a yarn made of polyethylene with rubber includes a method for coating a yarn made of polyethylene with a liquid where rubber is dispersed, and a method for immersing a yarn made of polyethylene in a liquid tank of a dispersion liquid where rubber is dispersed. While such coating or immersing allows the plasma treated surface of the yarn made of polyethylene to be almost entirely covered with the rubber, a mode where the plasma treated surface is partially covered with the rubber is also encompassed in the present invention.

After rubber-covering, the outermost layer can be coated with a covering layer of a smoothing agent such as an amino-modified silicone or a fluorine-containing oil.

### EXAMPLES

Hereinafter, the present invention is described with reference to Examples in more detail.

### Example 1

[Production of Yarn Made of Polyethylene]

Four of ultrahigh molecular weight polyethylene fibers (165 dTex/140 f) “Dyneema® grade SK60” produced by TOYOBO CO., LTD. were prepared. Such four original yarns were used and braided, thereby providing a multifilament yarn (702 dTex). The multifilament yarn had a circle equivalent diameter of about 350 μm and a single yarn circle equivalent diameter of about 12 μm.

[Plasma Treatment Step]

The multifilament yarn was subjected to a plasma treatment. The plasma treatment was made using a plasma treatment apparatus illustrated in FIG. 12 in International Publication No. WO 2014/167626 under conditions of a yarn speed of 5 m/min and a nitrogen gas flow rate of 3 L/min so that the surface was modified.

[Covering Step]

A solution was obtained by diluting a chloroprene rubber-containing resin WG22 produced by Konishi Co., Ltd. with water so that the ratio of WG22 relative to 100 parts by mass of water was 38 parts by mass. To this solution was added and mixed 11% by mass of a pigment where a green pigment and a black pigment were mixed as colorants, to prepare a solution. The surface of the multifilament yarn subjected to the plasma treatment was coated with the prepared solution, and dried to provide a yarn of Example 1 of the present invention.

### Examples 2 to 4

Four of ultrahigh molecular weight polyethylene fibers (165 dTex/140 f) “Dyneema® grade SK60” produced by TOYOBO CO., LTD. were prepared. Such four original yarns were used and braided, thereby providing a multifilament yarn (702 dTex). After this filament yarn was subjected to the same plasma treatment step as in Example 1, the same manner as in Example 1 was made except that the ratios of the chloroprene rubber containing resin WG22 in [covering step], relative to 100 parts by mass of water, were adjusted to 1 part by mass (Example 2), 5 parts by mass (Example 3) and 10 parts by mass (Example 4), respectively, thereby providing respective yarns of Examples 2 to 4.

### Examples 5 to 7

Four of ultrahigh molecular weight polyethylene fibers (165 dTex/140 f) “Dyneema® grade SK60” produced by TOYOBO CO., LTD. were prepared. Such four original yarns were used and braided, thereby providing a multifilament yarn (702 dTex). After this filament yarn was subjected to the same plasma treatment step as in Example 1, the same manner as in Example 1 was made except that the ratios of the chloroprene rubber containing resin WG22 in [covering step], relative to 100 parts by mass of water, were prepared to 19 parts by mass (Example 5), 38 parts by mass (Example 6) and 75 parts by mass (Example 7), respectively, and furthermore the surface of the multifilament yarn subjected to the plasma treatment was coated and thereafter dried.

Next, the surface was coated with an amino-modified silicone “Marposilcoat EX-G5” produced by Matsumoto Yushi-Seiyaku Co., Ltd., thereby providing respective yarns of Examples 5 to 7 of the present invention.

### Example 8

The fishing line of Example 1 was again subjected to the plasma treatment in [plasma treatment step], and thereafter the surface was coated with an amino-modified silicone “Marposilcoat EX-G5” produced by Matsumoto Yushi-Seiyaku Co., Ltd., thereby providing a yarn of Example 8.

### Comparative Example 1

A yarn of Comparative Example 1, being an existing product, was prepared. The yarn of Comparative Example 1 was a fishing line made of polyethylene, trade name “BASS SUPER PE LINE” produced by SUNLINE CO., LTD. This fishing line was formed by covering the surface of a multifilament yarn (702 dTex) obtained by braiding by use of four original yarns of ultrahigh molecular weight polyethylene fibers (165 dTex/140 f) “Dyneema® grade SK60” produced by TOYOBO CO., LTD., with a urethane resin, in other words, rubber made of urethane. Herein, the multifilament yarn was subjected to no plasma treatment.

### Comparative Example 2

Four of ultrahigh molecular weight polyethylene fibers (165 dTex/140 f) “Dyneema® grade SK60” produced by TOYOBO CO., LTD. were prepared. Such four original yarns were used and braided, thereby providing a multifilament yarn (702 dTex). This multifilament yarn was used as it was, in other words, the multifilament yarn of Example 1 subjected to no plasma treatment step and no covering step was adopted in Comparative Example 2.

### Comparative Examples 3 and 4

A fishing line made of nylon, Machinegun Cast #3 produced by SUNLINE CO., LTD., not subjected any surface treatment such as covering or coating, was adopted in Comparative Example 3. In addition, a fishing line made of fluorocarbon, Super Tornado #3 produced by SUNLINE CO., LTD., not subjected any surface treatment such as covering or coating, was adopted in Comparative Example 4.

Each sample of Examples 1 to 8 and Comparative Examples 1 to 4 was subjected to the following tests, and respective characteristics were evaluated in terms of a yarn, in particular, a fishing line.

<Respective Tests and Evaluations>

(1) Knotability Test 1 (Knot Strength Between Yarns)

Two samples having a length of 12.5 cm were prepared, and a tip of one of them was knotted to the center of the other by square knotting, and the maximum tenacity in slipping or loosening of a knot or in yarn breakage at the knot during pulling of the yarn which knotted and the yarn which was knotted was measured with a tensile measurement machine, and was subjected as the sample fineness to conversion to the node strength (cN/dTex). Tensilon (ORIENTEC RTE-1210) manufactured by ORIENTEC Co., LTD. was used as a tensile tester, and the test was conducted under conditions of a length of specimen between grips of 25 cm and a tension speed of 30 cm/min. The test was conducted for three samples, and the average value was defined as the knot strength.

(2) Knotability Test 2 (Knot Strength Between Metal and Yarn)

A polyethylene yarn (No. 5 size) was knotted to one ring of a fishing metal tool: barrel type swivel No. 10 manufactured by N.T. Swivel. Co., Ltd.; and one sample having a length of 12.5 cm was knotted to the other ring thereof by square knotting, and the maximum tenacity in slipping or loosening of a knot between the sample and the ring or in yarn breakage at the knot was measured with a tensile measurement machine, and was subjected as the sample fineness to conversion to the node strength (cN/dTex). Tensilon (ORIENTEC RTE-1210) manufactured by ORIENTEC Co., LTD. was used as a tensile tester, and the test was conducted under conditions of a length of specimen between grips of 25 cm and a tension speed of 30 cm/min. The test was conducted for three samples, and the average value was defined as the knot strength.

(3) Rubbing Fastness Test

Measurement was made by a “visual method” (a sample was rubbed by a white cotton cloth for rubbing and the degree of coloration of the white cotton cloth for rubbing was compared with grayscale for staining) according to JIS L0849 (2013) “test for color fastness to rubbing”. A Gakushin-type rubbing fastness tester manufactured by DAIEI KAGAKU SEIKI MFG. CO., LTD was used as a rubbing tester.

(4) Water Repellent Effect Test

The water contact angle was used as an indicator of the water repellent effect. A plate where a sample was wound as a single layer so that there was no gap between yarns aligned was prepared, and 4 cm³ of pure water was dropped on the yarns and the contact angle of the yarns with water was measured after 5 seconds. A water contact angle meter PG-X manufactured by FIBRO System AB was used for the measurement.

(5) Tensile Test

The tensile strength (cN/dTex) and the tensile elongation (%) were measured according to the method described in 8.5 section “Tensile strength and elongation rate” in JIS L1013 (2010) “Chemical fiber filament yarn test method”. Tensilon (ORIENTEC RTE-1210) manufactured by ORIENTEC Co., LTD. was used to conduct the test under conditions of a sample length of 25 cm and a tension speed of 30 cm/min. The test was conducted for three samples, and the average values were defined as the tensile strength and the tensile elongation.

(6) Node Test

The node strength (cN/dTex) was measured according to the method described in 8.6 section “Node strength” in JIS L1013 (2010) “Chemical fiber filament yarn test method”. Tensilon (ORIENTEC RTE-1210) manufactured by ORIENTEC Co., LTD. was used to conduct the test under conditions of a sample length of 25 cm and a tension speed of 30 cm/min. The test was conducted for three samples, and the average values were defined as the tensile strength and the tensile elongation.

The results of the tests performed in Examples and Comparative Examples described above are shown below.

The results of (1) Knotability test 1 (knot strength between yarns) and (2) Knotability test 2 (knot strength between metal and yarn) are collectively shown in Table 1. The fishing line subjected to the plasma treatment and then rubber-covered, of each of Examples 1 to 4, exhibited 2.3 times or more the strength in Comparative Example 2 in terms of square knotting, exhibited 4.1 times or more the strength in Comparative Example 2 in terms of swivel-square knotting, and exhibited a better knot strength than those of the yarns of Comparative Examples 1 to 4. Such results indicate a remarkable enhancement in knot strength even in terms of square knotting which is the simplest, namely, it can be said that knotability is enhanced.

TABLE 1

| | | Knotability | | | |
|---|---|---|---|---|---|
| | | (knot strength at the start of slipping) | | | |
| | | Square knotting | | Swivel-square knotting | |
| | | | Strength | | Strength |
| | Fineness | Strength | ratio | Strength | ratio |
| | (*1) (dTex) | (CN/dTex) | (times) | (CN/dTex) | (times) |
| Example 1 | 741 | 0.28 | 7.0 | 0.98 | 7.5 |
| Example 2 | 698 | 0.09 | 2.3 | 0.53 | 4.1 |
| Example 3 | 722 | 0.14 | 3.5 | 0.57 | 4.4 |
| Example 4 | 730 | 0.18 | 4.5 | 0.62 | 4.8 |
| Comparative | 717 | 0.05 | 1.3 | 0.40 | 3.1 |
| Example 1 | | | | | |
| Comparative | 702 | 0.04 | base | 0.13 | base |
| Example 2 | | | | | |
| Comparative | 704 | 0.02 | 0.5 | 0.66 | 5.1 |
| Example 3 | | | | | |
| Comparative | 1226 | 0.08 | 2.0 | 0.58 | 4.5 |
| Example 4 | | | | | |

(*1) Fineness (dTex) = Yarn mass (g) per 10,000 m
Strength ratio: strength ratio relative to Comparative Example 2

The results of (3) Rubbing fastness test are shown in Table 2. The results shown in Table 2 indicate that a larger numerical value represents a better property. The fishing line of Example 1, subjected to the plasma treatment and then rubber-covered, was rated as fourth grade, and had a better rubbing fastness than that of Comparative Example 1 where an existing product was simulated, rated as second to third grade.

TABLE 2

| | Fineness | Rubbing fastness |
|---|---|---|
| | (*1) (dTex) | (*2) |
| Example 1 | 741 | Fourth grade |
| Comparative | 717 | Second to third grade |
| Example 1 | | |

(*1) Fineness (dTex) = Yarn mass (g) per 10,000 m
(*2) According to JlSL0849 (rubbing color fastness test). A larger numerical value represents a better result.

The results of (4) Water repellent effect test are shown in Table 3. While ingress of water between filaments was caused and no water repellent effect was exerted in Comparative Example 1 where an existing product was simulated, the shape of water droplets was kept even after 5 seconds and water repellency performance was exhibited in Example 8 where the surface was subjected to the plasma treatment and then rubber-covered, and further subjected to the plasma treatment and then coated with the amino-modified silicone.

TABLE 3

| | Water contact angle (degrees) |
|---|---|
| Example 8 | 104.3 |
| Comparative Example 1 | 0.0 |

The results of (5) Tensile strength test and (6) Node test are shown in Table 4. The fishing line of each of Examples 5 to 7 where rubber-covering was made after the plasma treatment was enhanced in tensile strength and node strength as compared with Comparative Example 1 and Comparative Example 2. Specifically, those of Examples 5 to 7 exhibited 1.08 to 1.21 times the tensile strength and the knot strength in Comparative Example 2.

TABLE 4

| | | Tensile test | | | Node test | | |
|---|---|---|---|---|---|---|---|
| | Fineness | Tensile | Strength | Tensile | Node | Strength | Node |
| | (*1) | strength | ratio | elongation | strength | ratio | elongation |
| | (dTex) | (CN/dTex) | (times) | (%) | (cN/dTex) | (times) | (%) |
| Example 5 | 721 | 20.7 | 1.08 | 6.4 | 7.3 | 1.09 | 3.4 |
| Example 6 | 727 | 21.1 | 1.11 | 6.4 | 8.2 | 1.21 | 3.6 |
| Example 7 | 757 | 21.2 | 1.11 | 5.9 | 7.9 | 1.18 | 3.2 |
| Comparative | 717 | 18.7 | 0.98 | 6.8 | 7.1 | 1.06 | 4.1 |
| Example 1 | | | | | | | |
| Comparative | 702 | 19.1 | base | 7.0 | 6.7 | base | 4.0 |
| Example 2 | | | | | | | |

(*1) Fineness (dTex) = Yarn mass (g) per 10,000 m
Strength ratio: strength ratio relative to Comparative Example 2

Examples 2 to 4 shown in Table 5 are examples different in only the amount of rubber-covering from one another, and Examples 5 to 7 are also examples different in only the amount of rubber-covering from one another.

From Table 5, the present invention can allow the amount of rubber-covering to be adjusted within a wide range depending on desired characteristics. For example, the amount of a resin to be compounded to 100 parts by mass of water can be adjusted within the range from 1 part by mass to 75 parts by mass. The amount of rubber-covering can be adjusted to thereby freely control, for example, the weight of a yarn, and the texture and tension of the surface thereof.

TABLE 5

| | Amount of | Fineness | | |
|---|---|---|---|---|
| | WG22 to be | of original | Fineness | Coating % |
| | compounded | yarn (dTex) | (*1) (dTex) | (*2) |
| Example 2 | 1 part by mass | 702 | 698 | −0.6 |
| Example 3 | 5 parts by mass | 702 | 722 | 2.8 |
| Example 4 | 10 parts by mass | 702 | 730 | 3.8 |
| Example 5 | 19 parts by mass | 702 | 721 | 2.6 |
| Example 6 | 38 parts by mass | 702 | 727 | 3.4 |
| Example 7 | 75 parts by mass | 702 | 757 | 7.3 |
| Comparative | Urethane resin | 702 | 717 | 2.1 |
| Example 1 | | | | |

(*1) Fineness (dTex) = Yarn mass (g) per 10,000 m
(*2) Coating % = (Fineness of yarn processed (dTex) - Fineness of original yarn (dTex))/Fineness of yarn processed (dTex) × 100

Examples 2 to 7 shown in Table 5 above are examples different in the amount of resin WG22 to be compounded to 100 parts by mass of water. Resin WG22 has a chloroprene content of 50%, and therefore the amount of the rubber to be compounded to 100 parts by mass of water is half the amount of resin WG22 to be compounded.

The square knotting strength and the swivel-square knotting strength in each of Examples 2 to 7 are shown in Table 6. In addition, the relationship between the amount of the rubber to be compounded and the strength in each of Examples 2 to 7 is represented in the graph in FIG. 4.

TABLE 6

| | | Amount of rubber | | |
|---|---|---|---|---|
| | Amount of | component to be | | Swivel- |
| | WG22 to be | compounded | Square | square |
| | compounded | in solution | knotting | knotting |
| | [parts by | [parts by | strength | strength |
| | mass] | mass] | cN/dTex | CN/dTex |
| Example 2 | 1 | 0.5 | 0.09 | 0.53 |
| Example 3 | 5 | 2.5 | 0.14 | 0.57 |
| Example 4 | 10 | 5 | 0.18 | 0.62 |
| Example 5 | 19 | 9.5 | 0.22 | 0.62 |
| Example 6 | 38 | 19 | 0.31 | 0.88 |
| Example 7 | 75 | 37.5 | 0.37 | 1.13 |

It was revealed from Table 6 and FIG. 4 that rubber-covering resulted in a high knotting strength as compared with that of the existing product (Comparative Example 1) and the knotting strength was increased according to an increase in the amount of the rubber to be compounded. From these results, the amount of the rubber to be compounded to 100 parts by mass of water is preferably 0.5 parts by mass or more, more preferably 2.5 parts by mass or more.

Characteristics in Examples 1 to 8 and Comparative Examples 1 to 4 described above are tabularized and shown in Table 7. Table 7 also shows characteristics in Examples 9 to 15 and Comparative Examples 5 to 11.

Examples 9 to 13 corresponded to Examples 1 and 5 to 8, respectively, where the sample was subjected to the same treatment provided that the gas was a nitrogen gas containing 1% by volume of an oxygen gas in the plasma treatment and other treatment conditions were the same as those in Examples 9 to 13.

Example 14 was an example where the yarn made of polyethylene was the same as in Example 1, and was subjected to the same plasma treatment as in Example 1 and covered with a urethane resin as the rubber, namely, covered with urethane rubber. No amino-modified silicone covering film was applied.

Example 15 was an example where the yarn made of polyethylene was the same as in Example 1, and was subjected to the same plasma treatment as in Examples 9 to 13 and covered with a urethane resin as the rubber, namely, covered with urethane rubber. No amino-modified silicone covering film was applied.

Comparative Example 5 was an example where the yarn made of polyethylene was the same as in Example 1, and was covered with a urethane resin as the rubber and subjected to no plasma treatment. No amino-modified silicone covering film was applied.

Comparative Example 6 was an example where the yarn made of polyethylene was the same as in Example 1, and was covered with an acrylic resin instead of the rubber and subjected to no plasma treatment. No amino-modified silicone covering film was applied. The acrylic resin used was KASESOL F-10 produced by NICCA CHEMICAL CO., LTD.

Comparative Example 7 was an example where the yarn made of polyethylene was the same as in Example 1, and was covered with an acrylic resin instead of the rubber and subjected to no plasma treatment. No amino-modified silicone covering film was applied. The acrylic resin used was EDC-24 produced by Dainichiseika Color & Chemicals Mfg. Co., Ltd.

Comparative Example 8 was an example where the yarn made of polyethylene was the same as in Example 1, and was covered with an acrylic resin instead of the rubber and subjected to the same plasma treatment as in Example 1. No amino-modified silicone covering film was applied. The acrylic resin used was EDC-24 produced by Dainichiseika Color & Chemicals Mfg. Co., Ltd.

Comparative Example 9 was an example where the yarn made of polyethylene was the same as in Example 1, and was subjected to no plasma treatment and covered with the same rubber as in Example 1 in the same amount as in Example 1. No amino-modified silicone covering film was applied.

Comparative Example 10 was an example where the yarn made of polyethylene was the same as in Example 1, and was subjected to no plasma treatment and covered with the same rubber as in Example 1 in the same amount as in Example 1, and was subjected to no plasma treatment and coated with an amino-modified silicone covering film.

Comparative Example 11 was an example where the yarn made of polyethylene was the same as in Example 1, was covered with rubber different from that in Example 1 in the same amount as in Example 1, and was subjected to no plasma treatment and coated with an amino-modified silicone covering film.

TABLE 7

| | | | | | | | | | Swivel- |
|---|---|---|---|---|---|---|---|---|---|
| | | | | | | | | Square | square |
| | | Tensile test | | | Node test | | | knotting | knotting |
| | Fineness | Tenacity | Strength | | Tenacity | Strength | | strength | Strength |
| Sample | dTex | cN | cN/dTex | Elongation % | cN | cN/dTex | Elongation % | cN/dTex | cN/dTex |
| Comparative | 702 | 13398 | 19.09 | 7.04 | 4711 | 6.71 | 4.02 | 0.04 | 0.13 |
| Example 2 | | | | | | | | | |
| Original yarns | 702 | 13398 | 19.09 | 7.04 | 4711 | 6.71 | 4.02 | 0.04 | 0.13 |
| of Exs. 1 to 15 | | | | | | | | | |
| Original yarns | 702 | 13398 | 19.09 | 7.04 | 4711 | 6.71 | 4.02 | 0.04 | 0.13 |
| of Comparative | | | | | | | | | |
| Exs. 5 to 13 | | | | | | | | | |
| Example 1 | 741 | 14152 | 19.10 | 6.54 | 5625 | 7.59 | 4.01 | 0.28 | 0.98 |
| Example 2 | 698 | 13913 | 19.93 | 5.90 | 5458 | 7.82 | 3.30 | 0.09 | 0.53 |
| Example 3 | 722 | 13537 | 18.75 | 6.00 | 5235 | 7.25 | 3.50 | 0.14 | 0.57 |
| Example 4 | 730 | 14239 | 19.51 | 5.60 | 5651 | 7.74 | 3.13 | 0.18 | 0.62 |
| Example 5 | 721 | 14920 | 20.69 | 6.37 | 5259 | 7.29 | 3.36 | 0.22 | 0.62 |
| Example 6 | 727 | 15346 | 21.11 | 6.39 | 5927 | 8.15 | 3.56 | 0.31 | 0.88 |
| Example 7 | 757 | 16024 | 21.17 | 5.94 | 6004 | 7.93 | 3.19 | 0.37 | 1.13 |
| Example 8 | 748 | 15277 | 20.42 | 6.07 | 5909 | 7.90 | 3.39 | — | — |
| Comparative | 717 | 13417 | 18.71 | 6.82 | 5119 | 7.14 | 4.13 | 0.05 | 0.40 |
| Example 1 | | | | | | | | | |
| Comparative | 704 | — | — | — | — | — | — | 0.02 | 0.66 |
| Example 3 | | | | | | | | | |
| Comparative | 1226 | — | — | — | — | — | — | 0.08 | 0.58 |
| Example 4 | | | | | | | | | |
| Example 9 | 736 | 14526 | 19.74 | 6.26 | 5975 | 8.12 | 3.69 | 0.28 | 1.04 |
| Example 10 | 718 | 14899 | 20.75 | 6.08 | 5893 | 8.21 | 3.13 | — | — |
| Example 11 | 732 | 14736 | 20.13 | 6.27 | 5911 | 8.08 | 3.48 | — | — |
| Example 12 | 742 | 15591 | 21.01 | 5.80 | 6425 | 8.66 | 3.19 | — | — |
| Example 13 | 731 | 15231 | 20.84 | 6.21 | 5888 | 8.05 | 3.50 | — | — |
| Example 14 | 712 | 15655 | 21.99 | 5.79 | 5760 | 8.09 | 3.14 | 0.28 | 0.85 |
| Example 15 | 734 | 14713 | 20.05 | 6.58 | 5752 | 7.84 | 3.88 | 0.24 | 0.75 |
| Comparative | 732 | 14765 | 20.17 | 6.59 | 5526 | 7.55 | 3.83 | 0.09 | 0.42 |
| Example 5 | | | | | | | | | |
| Comparative | 749 | 13913 | 18.58 | 5.90 | 5458 | 7.29 | 3.30 | 0.08 | 0.26 |
| Example 6 | | | | | | | | | |
| Comparative | 721 | 13537 | 18.78 | 6.00 | 5235 | 7.26 | 3.50 | 0.06 | 0.21 |
| Example 7 | | | | | | | | | |
| Comparative | 716 | 14239 | 19.89 | 5.60 | 5651 | 7.89 | 3.13 | 0.06 | 0.46 |
| Example 8 | | | | | | | | | |
| Comparative | 745 | 14329 | 19.23 | 6.23 | 5741 | 7.71 | 3.74 | 0.15 | 0.82 |
| Example 9 | | | | | | | | | |
| Comparative | 743 | 14151 | 19.05 | 6.15 | 5460 | 7.35 | 3.36 | 0.10 | 0.66 |
| Example 10 | | | | | | | | | |
| Comparative | 743 | 14244 | 19.17 | 6.39 | 5630 | 7.58 | 3.45 | 0.14 | 0.57 |
| Example 11 | | | | | | | | | |

From Table 7, Example 1 where the plasma treatment was performed and covering with the rubber was made was extremely excellent in square knotting strength and swivel-square knotting strength as compared with Comparative Example 9 where no plasma treatment was performed and covering with the rubber was made. In addition, Example 6 where the plasma treatment was performed and covering with the rubber and covering with the amino-modified silicone were made was extremely excellent in swivel-square knotting strength as compared with Comparative Example 10 where no plasma treatment was performed and covering with the rubber and covering with the amino-modified silicone were made.

### Example 16

Examples and Comparative Examples below are examples where the material of the original yarn was different.

One wholly aromatic polyester fiber (trade name “Zxion”) (110 dTex/48 f) produced by KB SEIREN, LTD. was prepared. Such one original yarn was not braided and was used as a multifilament yarn. After this filament yarn was subjected to the same plasma treatment step as in Example 1, the same manner as in Example 1 was made except that the ratio of the chloroprene rubber containing resin WG22 in [covering step], relative to 100 parts by mass of water, was adjusted to 38 parts by mass, thereby providing a yarn of Example 14.

### Example 17

Four para-type aramid fibers (trade name “Kevlar”) (110 dTex/about 66 f) produced by DU PONT-TORAY CO., LTD. were prepared. Such four original yarns were used and braided, to provide 482 dTex of a multifilament yarn. After this filament yarn was subjected to the same plasma treatment step as in Example 1, the same manner as in Example 1 was made except that the ratio of the chloroprene rubber-containing resin WG22 in [covering step], relative to 100 parts by mass of water, was adjusted to 38 parts by mass, thereby providing a yarn of Example 15.

### Comparative Example 12

One wholly aromatic polyester fiber (trade name “Zxion”) (110 dTex/48 f) produced by KB SEIREN, LTD. was prepared. Such one original yarn which was not braided and was used as a multifilament yarn as it was, in other words, the multifilament yarn of Example 14 subjected to no plasma treatment step and no covering step was used in Comparative Example 12. Comparative Example 12 was an example to be compared with Example 16.

### Comparative Example 13

Four para-type aramid fibers (trade name “Kevlar”) (110 dTex/about 66 f) produced by DU PONT-TORAY CO., LTD. were prepared. Such four original yarns were used and braided, to provide 482 dTex of a multifilament yarn. This multifilament yarn used as it was, in other words, the multifilament yarn of Example 15 subjected to no plasma treatment step and no covering step was used in Comparative Example 13. Comparative Example 13 was an example to be compared with Example 17.

The results of the tests performed with respect to the samples of Examples 16 and 17 and Comparative Examples 12 and 13 described above are indicated below. The results of Knotability test 1 (knot strength between yarns) and Knotability test 2 (knot strength between metal and yarn) are collectively shown in Table 8. The wholly aromatic polyester yarn subjected to the plasma treatment and then rubber-covered indicated the same tendency as that of the polyethylene yarn, namely, exhibited 2.3 times the square knotting and 3.5 times the swivel-square knotting on the original yarn basis; and the para-type aramid yarn subjected to the same treatment also indicated the same tendency as that of the polyethylene yarn, namely, exhibited 10.0 times the square knotting and 2.0 times the swivel-square knotting on the original yarn basis.

The results of the tensile strength test and the node test are shown in Table 9.

TABLE 8

| | | | Knotability | | | |
|---|---|---|---|---|---|---|
| | | | (knot strength at the start of slipping) | | | |
| | | | Square | | Swivel-square | |
| | | Fine- | knotting | | knotting | |
| | | ness | Strength | Strength | Strength | Strength |
| | | (*1) | (CN/ | ratio | (CN/ | ratio |
| | Fiber type | (dTex) | dTex) | (times) | dTex) | (times) |
| Example 16 | Wholly | 127 | 0.72 | 2.3 | 1.33 | 3.5 |
| | aromatic | | | | | |
| | polyester | | | | | |
| Comparative | Wholly | 112 | 0.32 | base | 0.38 | base |
| Example 12 | aromatic | | | | | |
| | polyester | | | | | |
| Example 17 | Para-type | 506 | 0.76 | 10.0 | 1.20 | 2.0 |
| | aramid | | | | | |
| Comparative | Para-type | 482 | 0.08 | base | 0.60 | base |
| Example 13 | aramid | | | | | |

(*1) Fineness (dTex) = Yarn mass (g) per 10,000 m
Strength ratio: strength ratio relative to Comparative Example 2

TABLE 9

| | | | Tensile test | | | Node test | | |
|---|---|---|---|---|---|---|---|---|
| | | Fineness | Tensile | Strength | Tensile | Tensile | Strength | Tensile |
| | Fiber | (*1) | strength | ratio | elongation | strength | ratio | elongation |
| | type | (dTex) | (cN/dTex) | (times) | (%) | (cN/dTex) | (times) | (%) |
| Example 16 | Wholly | 127 | 20.7 | 0.99 | 3.1 | 6.1 | 0.88 | 1.3 |
| | aromatic | | | | | | | |
| | polyester | | | | | | | |
| Comparative | Wholly | 112 | 20.9 | base | 3.2 | 6.9 | base | 1.5 |
| Example 12 | aromatic | | | | | | | |
| | polyester | | | | | | | |
| Example 17 | Para-type | 506 | 15.3 | 0.95 | 2.8 | 6.6 | 0.97 | 1.8 |
| | aramid | | | | | | | |
| Comparative | Para-type | 482 | 16.1 | base | 2.9 | 6.8 | base | 1.8 |
| Example 13 | aramid | | | | | | | |

(*1) Fineness (dTex) = Yarn mass (g) per 10,000 m
Strength ratio: strength ratio relative to Comparative Example 2

Characteristics of the wholly aromatic polyester yarn and the para-type aramid yarn in each of Examples 16 and 17 and Comparative Examples 12 and 13 described above are tabularized and shown in Table 10.

TABLE 10

| | | | | | | | | | Square | Swivel-square |
|---|---|---|---|---|---|---|---|---|---|---|
| | | | Tensile test | | | Node test | | | knotting | knotting |
| | Fiber | Fineness | Tenacity | Strength | | Tenacity | Strength | | strength | strength |
| Sample | type | dTex | cN | cN/dTex | Elongation % | cN | cN/dTex | Elongation % | cN/dTex | cN/dTex |
| Example 16 | Wholly | 127 | 2627 | 20.7 | 3.1 | 780 | 6.1 | 1.3 | 0.72 | 1.33 |
| | aromatic | | | | | | | | | |
| | polyester | | | | | | | | | |
| Comparative | Wholly | 112 | 2343 | 20.9 | 3.2 | 777 | 6.9 | 1.5 | 0.32 | 0.38 |
| Example 12 | aromatic | | | | | | | | | |
| | polyester | | | | | | | | | |
| Example 17 | Para- | 506 | 7723 | 15.3 | 2.8 | 3317 | 6.6 | 1.8 | 0.76 | 1.20 |
| | type | | | | | | | | | |
| | aramid | | | | | | | | | |
| Comparative | Para- | 482 | 7760 | 16.1 | 2.9 | 3263 | 6.8 | 1.8 | 0.08 | 0.6 |
| Example 13 | type | | | | | | | | | |
| | aramid | | | | | | | | | |

Although the yarn and the method for production of the same, of the present invention, have been described above with reference to Examples and Comparative Examples, the original yarn of the yarn of the present invention is not limited to any synthetic resin yarns described in Examples. The present inventors have confirmed that a yarn obtained by braiding four ultrahigh molecular weight polyethylene fibers “Dyneema grade SK60” produced by TOYOBO CO., LTD. (55 dTex/48 f) and four polyethylene terephthalate monofilaments (21 dTex) produced by SUNLINE CO., LTD., to provide a multifilament yarn, subjecting the multifilament yarn to the same plasma treatment as in the [covering step] of Example 1, coating the surface of the multifilament yarn with rubber, and drying the resultant is enhanced in square knotting strength and swivel-square knotting strength as compared with a yarn which is a multifilament yarn obtained by the same braiding as described above and is subjected to no plasma treatment and is coated with no rubber.

1. A yarn in which a plasma treated surface is formed on a surface of an original yarn and the plasma treated surface is covered with rubber.

2. The yarn according to claim 1, wherein the yarn is made of at least one synthetic resin selected from polyethylene, wholly aromatic polyester and wholly aromatic polyamide.

3. The yarn according to claim 1, wherein the yarn is a twisted yarn or a braided yarn.

4. The yarn according to claim 3, wherein the twisted yarn or the braided yarn is made of a multifilament yarn and the rubber is allowed to penetrate between such multifilament yarns which are adjacent.

5. The yarn according to claim 1, wherein the rubber is chloroprene rubber.

6. The yarn according to claim 1, wherein an outermost layer comprises a smoothing agent.

7. The yarn according to claim 1, wherein the yarn is a fishing line.

8. A long object in which the yarn according to claim 1 is used.

9. A method for producing a yarn, comprising subjecting a surface of an original yarn to a plasma treatment, and covering the surface subjected to a plasma treatment with rubber.

10. The method for producing a yarn according to claim 9, wherein the yarn is at least one synthetic resin selected from polyethylene, wholly aromatic polyester and wholly aromatic polyamide.

11. The method for producing a yarn according to claim 9, wherein the yarn is a twisted yarn or a braided yarn.

12. The method for producing a yarn according to claim 11, wherein the twisted yarn or the braided yarn is made of a multifilament yarn and the rubber is allowed to penetrate between such multifilament yarns which are adjacent.

13. The method for producing a yarn according to claim 9, wherein the rubber is chloroprene rubber.

14. The method for producing a yarn according to claim 9, comprising forming a layer of a smoothing agent after rubber-covering.

15. The method for producing a yarn according to claim 9, wherein the plasma treatment is conducted at a temperature less than a fusion temperature of the yarn.
